(19) United States
(12) Patent Application Publication
(10) Pub. No.: US 2010/0084185 A1
(43) Pub. Date: Apr. 8, 2010

(54) MEANS FOR CONNECTING A LIGHT FIXTURE TO A WALL

(76) Inventor: TSAFRIR BARMUCHA, Holon (IL)

Correspondence Address: DANIEL J SWIRSKY, 55 REUVEN ST., BEIT SHEMESH, 99544, IL

(21) Appl. No.: 12/555,816

(22) Filed: Sep. 9, 2009

(30) Foreign Application Priority Data
Oct. 7, 2008 (IL) 194620

(51) Int. Cl. H05K 7/14; B23P 11/00

(52) U.S. Cl. 174/542; 29/428

(57) ABSTRACT

In one aspect, the present invention is directed to means for connecting a light fixture to a wall, ceiling, and the like. The connecting means comprising: a junction box, having an opening; an connection box in which the form thereof corresponds to the form of the box opening, dimension(s) of the connection box being smaller than the corresponding dimension(s) of the opening, thereby generating a gap therebetween enabling free movement of the connection box with reference to the junction box; and fitting means, for fitting the position of the connection box with regard to the position of the junction box.

### FIELD OF THE INVENTION

The present invention relates to the field of light fixtures. More particularly, the invention relates to means for connecting a light fixture to a wall, ceiling, and so on.

### BACKGROUND OF THE INVENTION

Presently, due to the existing installation technologies of wall light fixtures, the base of an installed light fixture protrudes from the wall, resulting in a defective esthetic appearance of the light fixture.

Furthermore, existing technologies do not provide a solution for adjusting the angle of an installed light fixture with regard to the wall on which it is installed, in order to be vertical, and essentially the result depends on the skill of the installer.

It is an objective of the present invention to provide a solution for the above-mentioned and other problems of the prior art of installing light fixtures.

Other objectives and advantages of the invention will become apparent as the description proceeds.

### SUMMARY OF THE INVENTION

The following embodiments and aspects thereof are described and illustrated in conjunction with systems, tools methods, and so forth, which are meant to be merely illustrative, not limiting in scope.

In one aspect, the present invention is directed to offer a means for connecting a light fixture to a wall. The connecting means comprise of:
a junction box (4), having an opening;
a connection box (12) the form of which corresponding to the form of the opening of the junction box, and dimension(s) of the connection box being smaller than the corresponding dimension(s) of the opening, thereby generating a gap within whereby allowing a degree of freedom of connection box movement with reference to the junction box; and
fitting means (such as substance 38), for fitting the connection box in a desired state.
base (14) of light fixture The junction box may further comprise a space (8) for storing a transformer.

The connecting means may further comprise latches (24), for fixing the junction box to an aperture in the wall. This is effective mostly in non-cement or non-concrete walls.

The junction box may further comprise openings (26), through which the junction box can be attached to the wall. This is effective mostly during the casting of cement walls.

The fitting means may be a substance that hardens upon exposure to air or with passage of time, such as plaster, cement, an adherent, and so on.

The form of the opening (and correspondingly that of the connection box) may be square, rectangular, circular, and elliptic, and so on.

The light fixture may further comprise a connector, for connecting the light fixture to the base of the connection box. Such a connector may comprise of one or more threaded hollow bolts, a correspondence between the dimensions of the connection box and the dimensions of a part of the light fixture, and so forth.

The light fixture may be an outer light fixture, a spotlight, and so on.

The wall may be a cement wall, a wall made of concrete or bricks, plaster, and so on.

In another aspect, the present invention is directed to a method for installing a light fixture, the method comprising the steps of:
fixing a junction box in a wall;
adjusting the position of an connection box with regard to the junction box, the connection box having a degree of freedom with reference to the junction box;
connecting the light fixture to the base.
fitting base of light fixture to the connection box.
The fitting step may be carried out while preparing wire connections in the wall, after drilling a hole in it, and so on.

In addition to the exemplary aspects and embodiments described above, further aspects and embodiments will become apparent by reference to the figures and by studying the following detailed description.

### BRIEF DESCRIPTION OF THE DRAWINGS

The objectives and features of the present invention will become apparent from the following detailed description considered in conjunction with the accompanying drawings, in which:

FIG. 1 schematically illustrates a light fixture installed in a wall using a light fixture wall foundation (LFWF), according to one embodiment of the invention.

FIG. 2 is an exploded view that schematically illustrates the parts of the outer light fixture illustrated in FIG. 1. (detailed, exploded)

FIG. 3 is a cross section view that schematically illustrates the LFWF of FIG. 1 installed in a wall, according to one embodiment of the invention.

FIG. 4 is a cross section view that schematically illustrates a spotlight installed in a LFWF, according to one embodiment of the invention.

It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, are merely intended to conceptually illustrate the structures and procedures described herein. Reference numerals may be repeated among the figures in order to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In some instances, well-known methods, procedures, components and circuits have not been described in detail, for the sake of brevity.

The term Light Fixture Wall Foundation (LFWF) refers herein to a device that intermediates between a light fixture and a wall. Thus, instead of connecting a light fixture to the wall directly, the LFWF is installed in the wall, and the light fixture is connected to the LFWF. A LFWF is marked herein by reference numeral 2.

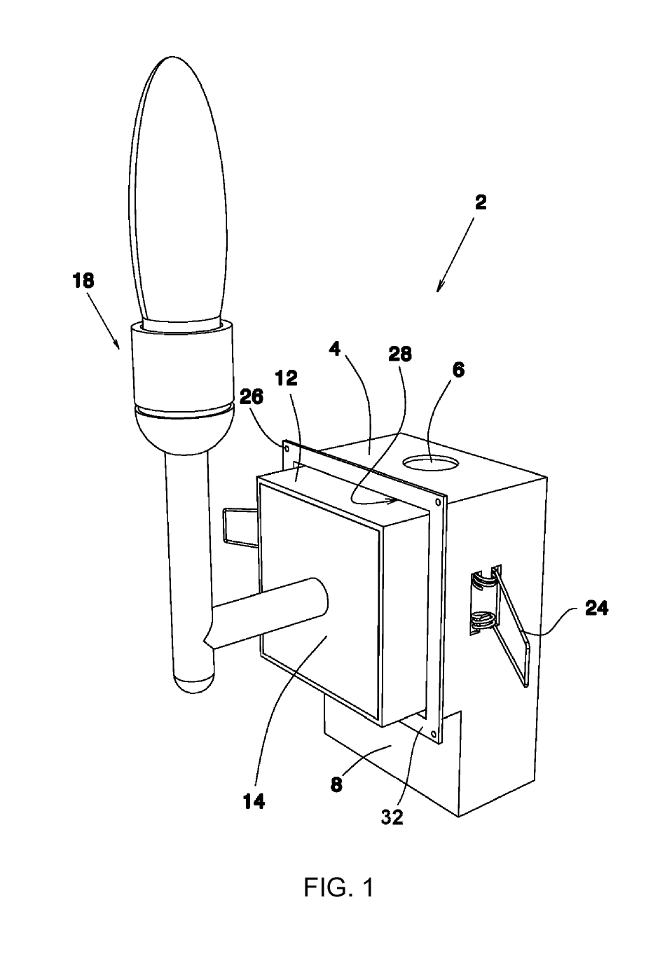

FIG. 1 schematically illustrates a light fixture installed in a wall using a light fixture wall foundation (LFWF), according to one embodiment of the invention.

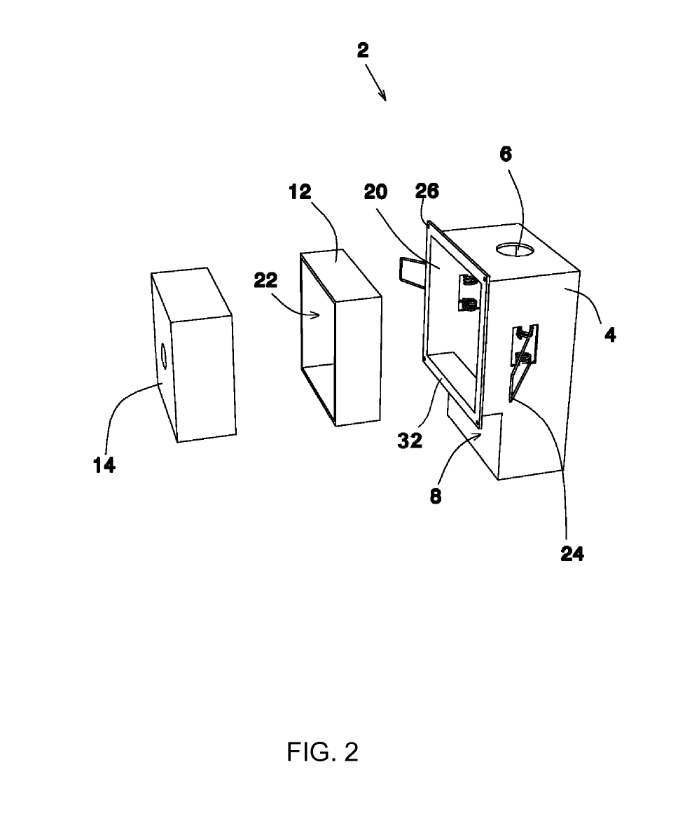

FIG. 2 is an exploded view that schematically illustrates the parts of the light fixture illustrated in FIG. 1.

In this example, the light fixture is an outer light fixture.

The LFWF illustrated in these figures comprises a “junction box” 4, which is a box made of rigid, preferably non-conductive material (such as plastic) or coated by non-conductive material.

The junction box is fixed into the wall, e.g., while casting. Another example of fixing a junction box into a wall is by drilling a hole into the wall, placing the box therein, and filling the remaining space with material such as cement, plaster, and the like.

The junction box comprises an opening 20, the size of which corresponds to the size of a connection box 12. The contour of the connection box corresponds to that of opening 20 of the junction box, but it's dimensions are smaller than those of opening 20 of the connection box, thereby leaving a gap (space) 28 therebetween. The objective of the gap is to allow changing the position of the connection box with reference to the junction box, or in other words, to provide some degree of freedom in placing the connection box with reference to the junction box, by so having the connection box embedded in the wall with its surface being as one with the wall. The connection box's form does not necessarily have to be square, as illustrated, but may also be circular, elliptic, rectangular, and so on, corresponding to the form of the opening of the junction box.

According to one embodiment of the invention, a frame 32 surrounds opening 20. The frame comprises one or more apertures 26, through which a bolt may be passed. This is useful for fitting during casting.

The form of the base of light fixture 18 corresponds to that of connection box 12, allowing one to fit into the other. In this example, the size of base 14, which is in box form, enables embedding the box-form base into the connection box's box-form. Base 14 can be secured to the connection box by securing means such as an adherent, bolts, and so forth.

Thus, the base of the light fixture is secured to the connection box, and the connection box is secured to the junction box. In other words, base 14 is inserted into connection box 12, and connection box 12 is inserted into the junction box 4. Since there is a gap between the connection box and the junction box, a user can adjust the position of the connection box with regard to the junction box, secure the connection box in this position, and then secure the base of the light fixture to the connection box.

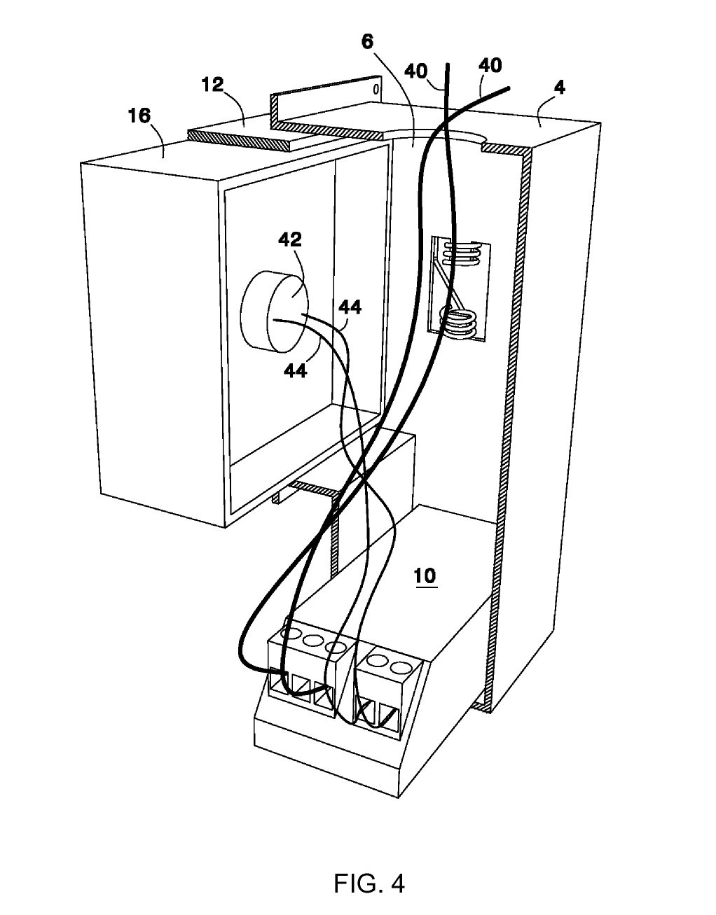

Numeral 8 denotes a space in the junction box, for storing a transformer (seen in FIG. 4 and marked by numeral 10), as some types of light fixtures include a transformer. Thus, according to embodiments of the present invention, the space for housing a transformer is already available in a LFWF.

A latch 24 can be used when placing the junction box inside a plaster wall and the like. If the junction box is installed while casting a wall, the latch may be omitted.

An opening 6 in the walls of the junction box allows passage of electric power into the box space.

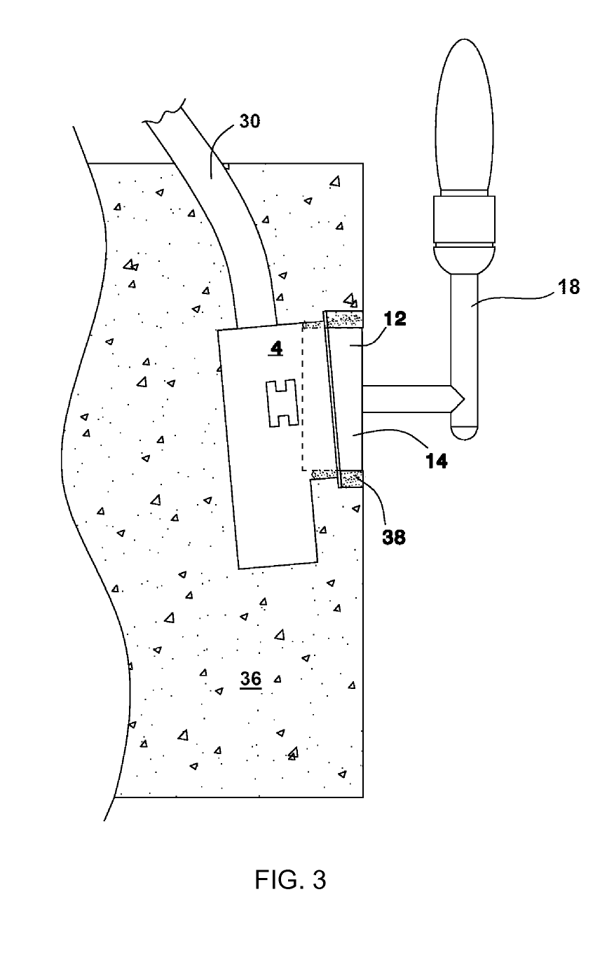

FIG. 3 is a cross section view that schematically illustrates the LFWF of FIG. 1 installed in a wall, according to one embodiment of the invention.

The wall, in this case a cast, is marked by reference numeral 36. As illustrated, the junction box 4 was installed inclined, and if the light fixture 18 had been connected to the junction box in the prior art technology, it would have been stand-inclined. However, since the light fixture is connected to connection box 12, as illustrated in this figure, the position of the connection box with regard to the wall can be adjusted to straight despite the fact that the junction box stands inclined.

As illustrated, gap 28 between the connection box and the junction box is filled with fixation substance 38, such as a fluid that hardens upon drying. For example, plaster, adherent, cement, and so on will do.

The term spotlight refers herein to a light fixture that comprises a receptacle for the lamp, such that the lamp does not pass beyond the edges of the receptacle. The receptacle may be in the form of a halved sphere, halved ellipse, halved square, and so on.

FIG. 4 is a cross section view that schematically illustrates a spotlight installed in a LFWF, according to one embodiment of the invention.

The spotlight, marked herein by numeral 16, is in the form of a square. The sectioned parts are connection box 12 and junction box 4. The illustration shows the location of transformer 10 in the junction box, and the wires that pass electricity from the transformer to the 12V bulb 42 of the spot.

The present invention provides the following advantages over the prior art:
drilling is not required to install a light fixture;
easier installation;
the light fixture extends directly from the wall (i.e., the base is hidden), providing an improved appearance in comparison to the prior art;
higher security level in comparison with the prior art, as wire connections are inside the junction box;
the junction box already comprises space for placing a transformer;
the invention can be implemented in concrete walls, brick walls made of construction blocks, Ittong™ blocks (trademark of a porous construction block), plaster, and the like.

Preferably, the dimensions of the LFWF are as follows:
The inner size of the junction box is about 7.4×7.4 cm. This enables easy insertion and extraction of a transformer in and out of the junction box.
The size of space 8 in which a transformer is placed is about 4×7.4 cm, which suits for the presently common light fixture transformers with no interference to a presently common spotlight.
The outer size of connection box 12 is about 7×7 cm. This suits for the presently common spot lights.
Frame 32 protrudes from the outer contour of the junction box by 6 mm. This provides suitable holding in a plaster wall, a ceiling and also in a casting.

In the figures and/or description herein, the following reference numerals have been mentioned:
numeral 2 denotes a light fixture wall foundation, according to one embodiment of the invention;
numeral 4 denotes a junction box;
numeral 6 denotes an opening in the junction box, for allowing passage of wires;
numeral 8 denotes a space in the junction box for storing a transformer;
numeral 10 denotes a transformer;
numeral 12 denotes a connection box;
numeral 14 denotes a base of light fixture 18;
numeral 16 a light fixture in the form of a spotlight;
numeral 18 denotes a light fixture in the form of a outer light fixture;
numeral 20 denotes an opening for the light fixture wall foundation, to which connection box 12 connects;
numeral 22 denotes an opening in connection box 12 to which a light fixture connects;
numeral 24 denotes a latch in the junction box for securing the junction box to a plaster wall;
numeral 26 denotes a aperture through which the junction box can be secured to a cement wall;
numeral 28 denotes a space between the connection box and the junction box;
numeral 30 denotes a pipe which connects to the opening 6 of the junction box, and through which wire can be passed;
numeral 32 denotes a frame, for securing the light fixture wall foundation to a wall, plaster wall, and so on;
numeral 36 denotes a wall;
numeral 38 denotes a fixation substance, such as gypsum;
numeral 40 denotes an electric power cable;
numeral 42 denotes a 12V bulb; and
numeral 44 denotes a wire of 12V from the transformer.

While certain features of the invention have been illustrated and described herein, the invention can be embodied in other forms, ways, modifications, substitutions, changes, equivalents, and so forth. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. Connecting means for connecting a light fixture to a wall, said connecting means comprising:
a junction box, having an opening;
an connection box wherein the form thereof corresponds to the form of said opening, at least one dimension of said connection box being smaller than the corresponding dimension of said opening, thereby generating a gap therebetween whereby generating a degree of freedom of moving the connection box with reference to the junction box; and
fitting means, for fixing the position of said connection box with regard to the position of said junction box.

2. Connecting means according to claim 1, wherein said junction box further comprises space for storing a transformer.

3. Connecting means according to claim 1, further comprising one or more latches, for fixing said junction box to an aperture thereof.

4. Connecting means according to claim 1, wherein said junction box further comprises a frame surrounding the opening thereof.

5. Connecting means according to claim 4, wherein said frame further comprises one or more apertures, for enabling attaching therethrough said junction box to a wall.

6. Connecting means according to claim 1, wherein said fitting means is selected from a group comprising: a substance that hardens upon exposure to air, a substance that hardens with passage of time, plaster, and cement.

7. Connecting means according to claim 1, wherein the form of said opening is selected from a group comprising: square, rectangular, circular, and elliptic.

8. Connecting means according to claim 1, wherein the light fixture thereof comprises a connector, for connecting said light fixture to said connection box.

9. Connecting means according to claim 8, wherein said connector is embodied by one or more threaded bolts.

10. Connecting means according to claim 8, wherein said connector is embodied by a correspondence between the dimensions of said connection box and the dimensions of a part of said light fixture.

11. Connecting means according to claim 8, wherein said light fixture is a wall outer light fixture.

12. Connecting means according to claim 8, wherein said light fixture is a spotlight.

13. Connecting means according to claim 1, wherein said wall is constructed by plaster.

14. Connecting means according to claim 1, wherein said wall is substantially made of blocks.

15. Connecting means according to claim 1, wherein said wall is a plaster wall.

16. Connection means according to claim 1, wherein the outer size of the opening of said junction box is about 7.4×7.4 cm.

17. Connection means according to claim 1, wherein the inner size of said connection box is about 7×7 cm.

18. Connection means according to claim 2, wherein the size of said space for storing a transformer is about 7.4×4 cm.

19. Connection means according to claim 4, wherein said frame protrudes from the outer contour of said junction box by about 6 mm.

20. A method for installing a light fixture, the method comprising the steps of:
fitting a junction box into a wall;
adjusting the position of an connection box with regard to said junction box, said connection box having a degree of freedom with reference to said junction box;
fitting said connection box to the current position by fitting means; and
connecting said light fixture to said connection box.

21. A method according to claim 20, wherein said fitting step is carried out while casting said wall.

22. A method according to claim 20, wherein said fitting step is carried out after drilling a hole in said wall.
